(19) United States
(12) Patent Application Publication
(10) Pub. No.: US 2024/0027081 A1
(43) Pub. Date: Jan. 25, 2024

(54) FUEL AGNOSTIC HEATING, VENTILATION, AIR CONDITIONING AND ELECTRICAL POWER GENERATION (HVAC-P) SYSTEM

(71) Applicant: Hyliion Inc., Cedar Park, TX (US)

(72) Inventors: Thomas Healy, Austin, TX (US); Patrick Sexton, Cedar Park, TX (US)

(21) Appl. No.: 18/352,505

(22) Filed: Jul. 14, 2023

Related U.S. Application Data
(60) Provisional application No. 63/390,588, filed on Jul. 19, 2022.

(51) Int. Cl. F24F 5/00; F24F 11/67; H02J 3/32

(52) U.S. Cl. CPC F24F 5/00; F24F 11/67; H02J 3/32; F24F 2221/34; F24F 2110/10

(57) ABSTRACT

Systems and methods of providing a heating, ventilation, air conditioning, and electrical power generation (HVAC-P) system are disclosed. The HVAC-P includes at least one generator, an optional battery system, and a system controller. The HVAC-P system is operable to generate and supply heating, cooling, and electrical power to a building (residential and/or commercial), camping trailer, recreational vehicle, or other habitable structure in which the HVAC-P system is installed. In the heating mode, the generator burns one or more fuels to generate and supply a heated airflow to the building, camping trailer, recreational vehicle, or other habitable structure and electrical power to the battery system, the building, the electrical grid, another generator, or a combination thereof. In the cooling mode, the generator operates on electrical power provided by the battery system, the electrical grid, another generator, or a combination thereof to generate and supply a cooled airflow to the building, camping trailer, recreational vehicle, or other habitable structure.

### CROSS-REFERENCE TO RELATED APPLICATIONS

This application claims the benefit of U.S. Provisional Patent Application No.: 63/390588, filed on Jul. 19, 2022, which is incorporated by reference herein in its entirety.

### FIELD

The present disclosure relates generally to heating, ventilation, and/or air conditioning systems and more particularly to fuel agnostic heating, ventilation, air conditioning and electrical power generation systems.

### BACKGROUND

Traditional heating, ventilation, and/or air conditioning (HVAC) systems often operate on electrical power provided by the electrical grid when operating in heating and cooling modes. Many traditional HVAC systems also burn natural gas in a furnace when operating in a heating mode. These HVAC systems are often costly to operate and provide limited functionality. With the growth of so-called “green” energy initiatives, industries continue to demand advances in technology that are more energy efficient and environmentally friendly.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 shows a schematic diagram of a fuel agnostic heating, ventilation, air conditioning, and electrical power generation (HVAC-P) system according to an embodiment of the disclosure.

FIG. 2 shows a schematic diagram of a fuel agnostic HVAC-P system according to an embodiment of the disclosure.

FIG. 3 shows a flowchart of a method of operating a fuel agnostic HVAC-P system according to an embodiment of the disclosure.

FIG. 4 shows a flowchart of a method of operating a fuel agnostic HVAC-P system according to an embodiment of the disclosure.

The use of the same reference symbols in different drawings indicates similar or identical items.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

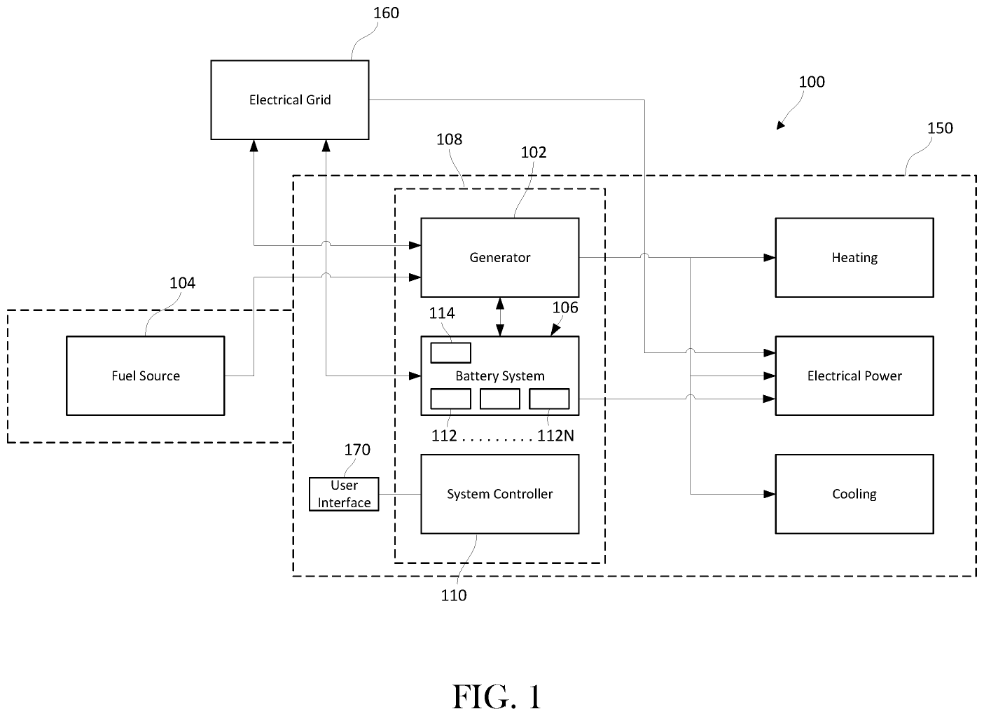

Referring now to the drawings, FIG. 1 shows a schematic diagram of a fuel agnostic heating, ventilation, air conditioning, and electrical power generation (HVAC-P) system 100 according to an embodiment of the disclosure. The HVAC-P system 100 may generally include a stationary system 150 that is configured for installation and operation in a building (residential and/or commercial). In some embodiments, the HVAC-P system 100 may be configured for installation and operation in a camping trailer, recreational vehicle, or other habitable structure requiring heating, cooling, and electrical power. However, in some embodiments, the HVAC-P system 100 may be a mobile or transportable freestanding autonomous unit that may be configured for operation outside of the building to provide similar benefits and operation as if the HVAC-P system 100 is installed in the building. The HVAC-P system 100 may be configured to generate and supply heating, cooling, and electrical power to the building or recreational vehicle. In some embodiments, the HVAC-P system 100 may also be configured to generate and supply electrical power to an electrical grid 160.

As shown, the HVAC-P system 100 may generally include a generator 102 coupled to one or more fuel sources 104 and/or the electrical grid 160. In some embodiments, the HVAC-P system 100 may also include a battery system 106 coupled to the generator 102 and/or the electrical grid 160. However, in some embodiments, the battery system 106 may be omitted. In some embodiments, the generator 102, the one or more fuel sources 104, and/or the battery system 106 may be disposed within or packaged in a housing 108. The HVAC-P system 100 may also include a system controller 110. In some embodiments, the system controller 110 may also be disposed within the housing 108 and/or coupled to the housing 108.

The generator 102 may generally include a fuel agnostic generator and may be configured to burn a variety of fuels, including compressed natural gas, liquified natural gas, diesel, hydrogen, liquified petroleum gas, propane, kerosene, dimethyl ether (DME), or any combination thereof to generate electrical power. Further, in an embodiment, the generator 102 may be coupled to the fuel source(s) 104 that supply one or more fuels to the generator 102. In some embodiments, the fuel source(s) 104 may include an external fuel source that supplies fuel via a municipality or utility provider. In some embodiments, the fuel source(s) 104 may include an internal fuel source having a fuel tank that stores fuel and supplies the fuel upon demand to the generator 102. In some embodiments, the generator 102 may include an ultra-low emissions generator, such that emissions from the generator 102 include only carbon dioxide, nitrogen, water, or a combination thereof. In some embodiments, the generator 102 may include a zero-emissions generator. In other embodiments, the generator 102 may include a cooling system configured to regulate an operating temperature of the generator 102 during combustion of the one or more fuels. Further, in some embodiments, the generator 102 may include a hydrogen fuel cell.

The generator 102 may be configured to selectively operate in each of a “heating” mode and a “cooling” mode. The generator 102 may be configured to generate and supply a temperature-conditioned airflow to the building or recreational vehicle. In the heating mode, the generator 102 may burn one or more fuels to generate and supply a heated airflow to the building or recreational vehicle. The heated airflow may generally refer to an airflow that has a higher temperature than an ambient air temperature in the building or recreational vehicle, and when supplied to the building or recreational vehicle, increases the ambient air temperature in the building or recreational vehicle. In some embodiments, the heated airflow generated by the generator 102 may be used to heat a water supply and function as a water heater. Additionally, in the heating mode, the generator 102 may generate electrical power for the battery system 106, the building or recreational vehicle, the electrical grid 160, and/or a combination thereof. In some embodiments, the generator 102 may supply the heated airflow to the building or recreational vehicle and simultaneously supply the generated electrical power to the battery system 106, the building or recreational vehicle, the electrical grid 160, or a combination thereof. In some embodiments, the heated airflow may be supplied through an exhaust system of the generator 102 and/or recaptured via a cooling system of the generator 102. In some embodiments, the generator 102 may be operated in the heating mode to generate electrical power for the battery system 106, the building or recreational vehicle, the electrical grid 160, or a combination thereof, and the heated airflow may be discarded and diverted away from the building or recreational vehicle. This may be referred to as a “power-only” mode.

In the cooling mode, the generator 102 may operate on electrical power provided by the battery system 106, the electrical grid 160, or a combination thereof to generate and supply a cooled airflow to the building or recreational vehicle. The cooled airflow may generally refer to an airflow that has a lower temperature than an ambient air temperature in the building or recreational vehicle, and when supplied to the building or recreational vehicle, decreases the ambient air temperature in the building or recreational vehicle. The generator 102 may generate the cooled airflow as a result of operating the generator 102 without burning the one or more fuels. In some embodiments, the cooled airflow may be supplied through the exhaust system of the generator 102 to the building or recreational vehicle. In some embodiments, the cooled airflow may be supplied to an enclosure (e.g., refrigeration unit or large walk-in food storage unit) to keep food or other contents cooled or frozen. Further, it will be appreciated that the generator 102 may not generate electrical power when operating in the cooling mode.

The generator 102 may selectively supply the generated electrical power to the battery system 106, the building or recreational vehicle, the electrical grid 160, or a combination thereof. In some embodiments, the generator 102 may selectively supply the generated electrical power to the battery system 106 to charge the battery system 106. In some embodiments, the generator 102 may selectively supply the generated electrical power to the building or recreational vehicle to operate electric or electronic components or systems of the building or recreational vehicle. In some embodiments, the generator 102 may selectively supply the generated electrical power through one or more electrical outlets in the building or recreational vehicle and may be configured to operate electric or electronic devices or systems that may be connected to the one or more electrical outlets.

In some embodiments, the generator 102 may selectively supply the generated electrical power to the electrical grid 160 to support the total electrical power available from the electrical grid 160. In some embodiments, the generator 102 may selectively supply the generated electrical power to the electrical grid 160 when the generator 102 generates more electrical power than required by the battery system 106, the building or recreational vehicle, or a combination thereof. In some embodiments, the generator 102 may selectively supply the generated electrical power to the electrical grid 160 upon a demand or request from the electrical grid 160.

The optional battery system 106 may include one or more batteries or battery packs 112. The generator 102 may supply the generated electrical power to the battery system 106 to charge the battery packs 112. The battery packs 112 may be configured to store electrical power and selectively supply the electrical power to the generator 102, the building or recreational vehicle, the electrical grid 160, or a combination thereof upon demand. The battery packs 112 may be electrically coupled in parallel, series, or a combination thereof depending on the application, configuration, and/or voltage requirements of the components or systems to which the battery system 106 may provide electrical power. For example, in some embodiments, the battery system 106 may provide an output of 12 VDC, 110 VAC, 220 VAC, or any other voltage output. In some embodiments, the battery system 106 may also include a battery management controller 114. The battery management controller 114 may be configured to selectively control an amount of the electrical power supplied from the battery packs 112 and/or the battery system 106. Further, in some embodiments, the battery management controller 114 may control the charging of the battery packs 112 and/or the battery system 106 by the generator 102.

The battery system 106 may generally be configured to supply electrical power to the generator 102, the building or recreational vehicle, the electrical grid 160, or a combination thereof. The battery system 106 may selectively supply the electrical power to the generator 102 to operate the generator 102 to generate and supply the cooled airflow in the cooling mode. The battery system 106 may selectively supply the electrical power to the building or recreational vehicle to operate electric or electronic components or systems of the building or recreational vehicle. The battery system 106 may selectively supply the electrical power through one or more electrical outlets in the building or recreational vehicle and be configured to operate electric or electronic devices or systems that may be connected to the one or more electrical outlets. In some embodiments, the battery system 106 may selectively supply the electrical power to the electrical grid 160 to support the total electrical power available from the electrical grid 160. In some embodiments, the battery system 106 may selectively supply the generated electrical power to the electrical grid 160 upon a demand or request from the electrical grid 160.

The housing 108 may generally be configured for installation in the building or recreational vehicle. The housing 108 may contain the generator 102, the fuel source(s) 104, the optional battery system 106, the system controller 110, or a combination thereof. The housing 108 may include any suitable shape (e.g., cylindrical, rectangular cuboid, etc.) and be sized suitable to the application. For example, in some embodiments suitable for residential applications, the housing 108 may include a maximum dimension (e.g., height or length) of less than 72 inches (about 1830 mm), less than 60 inches (about 1524 mm), less than 48 inches (about 1220 mm), or even less than 36 inches (about 915 mm). In some embodiments, the housing 108 may include dimensions substantially similar to standard residential water heaters. However, in some embodiments, the housing 108 may include a maximum dimension that is much larger. In some embodiments, the housing 108 may include one or more inlets and/or outlets that allow airflow through the housing 108. In some embodiments, the housing 108 may include one or more connections for electrical power outputs, heating outputs, and cooling outputs. In some embodiments, the housing 108 may include one or more connections for the fuel source(s) 104, the electrical grid 160, or a combination thereof.

The system controller 110 may generally execute instructions to control operation of the HVAC-P system 100. The system controller 110 may execute instructions to selectively operate the HVAC-P system 100 in each of the heating mode and the cooling mode. In some embodiments, the system controller 110 may also selectively operate the HVAC-P system 100 in the power-only mode. In some embodiments, the system controller 110 may execute instructions to selectively control delivery of the heated airflow and the cooled airflow to the building or recreational vehicle. In some embodiments, the system controller 110 may execute instructions to selectively control delivery of the generated electrical power from the generator 102 to the battery system 106, the building or recreational vehicle, the electrical grid 160, or a combination thereof. In some embodiments, the system controller 110 may execute instructions to selectively control delivery of the electrical power from the battery system 106 to the to the generator 102, the building or recreational vehicle, the electrical grid 160, or a combination thereof. In some embodiments, the system controller 110 may execute instructions to selectively control which of the fuel(s) are burned by the generator 102.

The system controller 110 may include and/or be communicatively coupled to one or more user interfaces 170. In some embodiments, the user interface 170 may be integrated with the system controller 110. In some embodiments, the user interface 170 may be remotely located from the system controller 110. In some embodiments, the system controller 110 and the user interface 170 may communicate through a wireless or wired network. The system controller 110 may be responsive to inputs made via the user interface 170. The system controller 110 may selectively operate the HVAC-P system 100 in each of the heating mode and the cooling mode in response to a demand for heating or cooling, respectively, received through the user interface 170 and/or in response to the ambient air temperature in the building or recreational vehicle exceeding a predetermined setpoint temperature stored in the user interface 170. In some embodiments, the system controller 110 may selectively operate the HVAC-P system 100 in response to a demand for electrical power received through the user interface 170, from the building or recreational vehicle, and/or from the electrical grid 160. Further in some embodiments, the system controller 110 may operate the HVAC-P system 100 to maintain a minimum state-of-charge of the battery system 106.

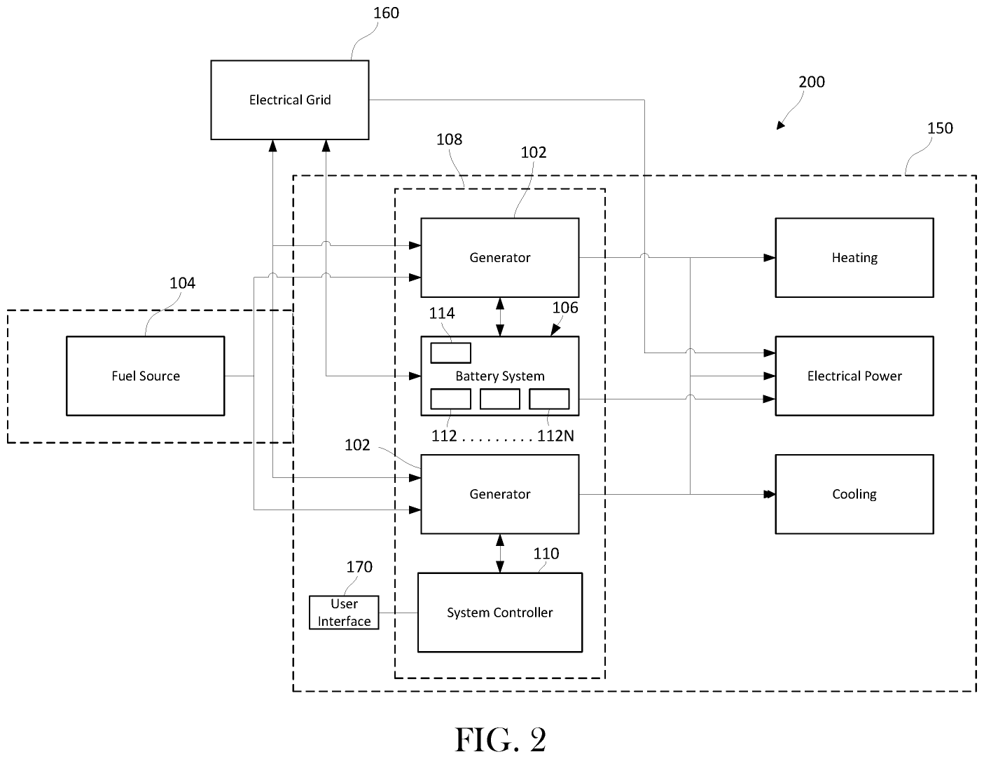

Referring now to FIG. 2, a schematic diagram of a fuel agnostic heating, ventilation, air conditioning, and electrical power generation (HVAC-P) system 200 according to an embodiment of the disclosure is illustrated. The HVAC-P system 200 may be substantially similar to HVAC-P system 100. However, as shown, the HVAC-P system 200 includes a plurality of generators 102. By providing the plurality of generators 102, the HVAC-P system 200 may be capable of providing heating and/or electrical power simultaneously with cooling. For example, as shown, the plurality of generators 102 includes a first generator 102 or a first set of generators 102 that may operate in the heating mode or power-only mode and burn one or more fuels to generate and supply a heated airflow and/or electrical power, and a second generator 102 or second set of generators 102 that may operate in the cooling mode to generate and supply a cooled airflow without burning the fuel(s). This mixed mode of operation may be beneficial when cooling is simultaneously required with heating and/or electrical power. For example, different areas or rooms of a building may have different predetermined setpoint temperatures based on the preferences of one or more occupants of each room or area. Further, while only two generators 102 are shown, it will be appreciated that the HVAC-P system 200 may include any number of generators 102 based on the size and/or heating, cooling, or electrical power requirements of the building or recreational vehicle. For example, in some embodiments, the HVAC-P system 200 may include at least two generators 102, at least three generators 102, at least four generators 102, or even more. Based on the heating, cooling, and/or electrical power demands, it will be appreciated that the generators 102 may be individually operable to deliver the required heating, cooling, and electrical power.

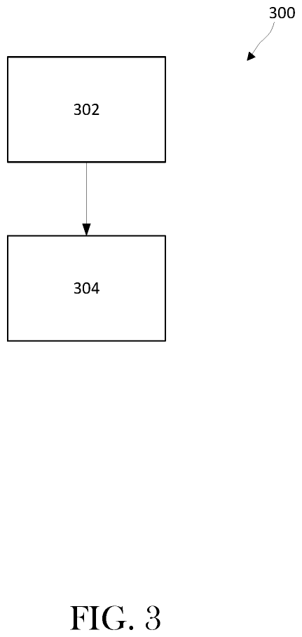

Referring now to FIG. 3, a flowchart of a method 300 of operating a fuel agnostic heating, ventilation, air conditioning, and electrical power generation (HVAC-P) system 100, 200 according to an embodiment of the disclosure is illustrated. As shown, the method 300 may begin at block 302 by providing an HVAC-P system 100, 200 including a generator 102 configured to selectively operate in each of a heating mode and a cooling mode, and a system controller 110 that executes instructions to selectively control operation of the HVAC-P system 100, 200 in each of the heating mode and cooling mode. The method 300 may continue at block 304 by selectively operating the HVAC-P system 100 in: the heating mode, wherein in the heating mode, the generator 102 burns one or more fuels to generate and supply a heated airflow to the building or recreational vehicle and electrical power to a battery system 106, the building or recreational vehicle, the electrical grid 160, or a combination thereof; or the cooling mode, wherein in the cooling mode, the generator 102 operates on electrical power provided by the battery system 106, the electrical grid 160, or a combination thereof to generate and supply a cooled airflow to the building or recreational vehicle. In some embodiments, the method 300 may further include operating the HVAC-P system 100 in the heating mode and switching from operating the HVAC-P system 100 in the heating mode to operating the HVAC-P system 100 in the cooling mode, and vice versa. In some embodiments, the method 300 may further include operating the HVAC-P system 100 in the cooling mode and switching from operating the HVAC-P system 100 in the cooling mode to operating the HVAC-P system 100 in the heating mode.

In some embodiments, the HVAC-P system 100 may be operated in the heating mode by the system controller 110 in response to a demand for heating and/or electrical power received through a user interface 170 communicatively coupled to the system controller 110, in response to an ambient air temperature in the building or recreational vehicle exceeding a predetermined setpoint temperature stored in the user interface 170, or a combination thereof. In some embodiments, the HVAC-P system 100 may be operated in the cooling mode by the system controller 110 in response to a demand for cooling received through the user interface 170 communicatively coupled to the system controller 110, in response to an ambient air temperature in the building or recreational vehicle exceeding a predetermined setpoint temperature stored in the user interface 170, or a combination thereof.

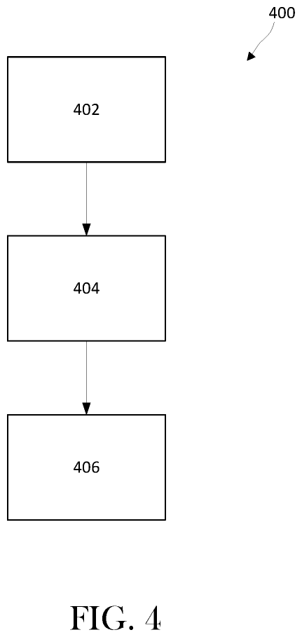

Referring now to FIG. 4, a flowchart of a method 400 of operating a fuel agnostic heating, ventilation, air conditioning, and electrical power generation (HVAC-P) system 200 according to an embodiment of the disclosure is illustrated. The method 400 may begin at block 402 by providing an HVAC-P system 200 comprising a plurality of generators 102 configured to independently operate in each of a heating mode and a cooling mode, and a system controller 110 that executes instructions to selectively control operation of the HVAC-P system 200 in each of the heating mode and cooling mode. The method 400 may continue at block 404 by operating at least one of the plurality of generators 102 in the heating mode, wherein in the heating mode, the generator 102 burns one or more fuels to generate and supply a heated airflow to the building or recreational vehicle and electrical power to a battery system 106, the building or recreational vehicle, the electrical grid 160, or a combination thereof. The method 400 may continue at block 404 by simultaneously operating at least one of the plurality of generators 102 in the cooling mode, wherein in the cooling mode, the generator 102 operates on electrical power provided by the battery system 106, the electrical grid 160, or a combination thereof to generate and supply a cooled airflow to the building or recreational vehicle.

In some embodiments, the method 400 may further include switching from operating at least one of the plurality of generators 102 of the HVAC-P system 200 in the heating mode to operating the at least one of the plurality of generators 102 of the HVAC-P system 200 in the cooling mode. In some embodiments, the method 400 may further include switching from operating at least one of the plurality of generators 102 of the HVAC-P system 200 in the cooling mode to operating at least one of the plurality of generators 102 of the HVAC-P system 200 in the heating mode. In some embodiments, the method 400 may further include operating each of the plurality of generators 102 of the HVAC-P system 200 in the heating mode. In some embodiments, the method 400 may further include operating each of the plurality of generators 102 of the HVAC-P system 200 in the cooling mode.

In some embodiments, at least one of the plurality of generators 102 of the HVAC-P system 200 may be operated in the heating mode by the system controller 110 in response to a demand for heating and/or electrical power received through a user interface 170 communicatively coupled to the system controller 110, in response to an ambient air temperature in the building or recreational vehicle exceeding a predetermined setpoint temperature stored in the user interface 170, or a combination thereof. In some embodiments, at least one of the plurality of generators 102 of the HVAC-P system 200 may be operated in the cooling mode by the system controller 110 in response to a demand for cooling received through the user interface 170 communicatively coupled to the system controller 110, in response to an ambient air temperature in the building or recreational vehicle exceeding a predetermined setpoint temperature stored in the user interface 170, or a combination thereof.

Further aspects are provided by the subject matter of the following clauses:

A heating, ventilation, air conditioning, and electrical power generation (HVAC-P) system for a building, comprising: a generator configured to selectively operate in each of a heating mode and a cooling mode, wherein, in the heating mode, the generator burns one or more fuels to generate and supply a heated airflow to the building and electrical power to a battery system, the building, the electrical grid, or a combination thereof, and wherein, in the cooling mode, the generator operates on electrical power provided by the battery system, the electrical grid, or a combination thereof to generate and supply a cooled airflow to the building; and a system controller that executes instructions to selectively control operation of the HVAC-P system in each of the heating mode and cooling mode.

The HVAC-P system of any preceding clause, wherein the generator includes a fuel agnostic generator.

The HVAC-P system of any preceding clause, wherein the fuel agnostic generator is configured to burn compressed natural gas, liquified natural gas, diesel, hydrogen, liquified petroleum gas, propane, kerosene, dimethyl ether (DME), or any combination thereof to generate electrical power to charge the battery system.

The HVAC-P system of any preceding clause, wherein emissions from the generator include only carbon dioxide, nitrogen, water, or a combination thereof.

The HVAC-P system of any preceding clause, wherein the heated airflow includes a higher temperature than an ambient air temperature in the building.

The HVAC-P system of any preceding clause, wherein the heated airflow increases the ambient air temperature in the building.

The HVAC-P system of any preceding clause, wherein the cooled airflow includes a lower temperature than an ambient air temperature in the building.

The HVAC-P system of any preceding clause, wherein the cooled airflow decreases the ambient air temperature in the building.

The HVAC-P system of any preceding clause, wherein, in the cooling mode, the generator is powered by electrical power from the battery system, the electrical grid, or a combination thereof without burning the one or more fuels.

The HVAC-P system of any preceding clause, wherein the generator selectively supplies the generated electrical power to the battery system to charge the battery system.

The HVAC-P system of any preceding clause, wherein the generator selectively supplies the generated electrical power to the building to operate electric or electronic components or systems of the building.

The HVAC-P system of any preceding clause, wherein the generator selectively supplies the generated electrical power through one or more electrical outlets in the building and is configured to operate electric or electronic devices or systems connected to the one or more electrical outlets.

The HVAC-P system of any preceding clause, wherein the generator selectively supplies the generated electrical power to the electrical grid to support the total electrical power available from the electrical grid.

The HVAC-P system of any preceding clause, wherein the generator selectively supplies the generated electrical power to the electrical grid when the generator generates more electrical power than required by the battery system, the building, or a combination thereof.

The HVAC-P system of any preceding clause, wherein the generator selectively supplies the generated electrical power to the electrical grid upon a demand or request from the electrical grid.

The HVAC-P system of any preceding clause, wherein the generator is configured to supply the generated electrical power to the battery system, the building, the electrical grid, or a combination thereof and simultaneously supply heating to the building.

The HVAC-P system of any preceding clause, further comprising: a cooling system coupled to the generator and configured to regulate an operating temperature of the generator.

The HVAC-P system of any preceding clause, wherein the generator is coupled to one or more fuel sources that supply the one or more fuels to the generator.

The HVAC-P system of any preceding clause, wherein the one or more fuel sources includes an internal fuel source having a fuel tank that stores fuel and supplies the fuel upon demand to the generator.

The HVAC-P system of any preceding clause, wherein the one or more fuel sources include an external fuel source that supplies fuel via a municipality or utility provider.

The HVAC-P system of any preceding clause, wherein the HVAC-P system includes a plurality of generators.

The HVAC-P system of any preceding clause, wherein the HVAC-P system is configured to selectively supply the heated airflow and/or electrical power simultaneously with the cooled airflow.

The HVAC-P system of any preceding clause, wherein a first generator or a first set of generators operates in the heating mode and burns one or more fuels to generate and supply the heated airflow and/or electrical power, and wherein a second generator or second set of generators operates in the cooling mode to generate and supply a cooled airflow without burning the one or more fuels.

The HVAC-P system of any preceding clause, wherein the heated airflow is provided to a first area or one or more first rooms of the building, and wherein the cooled airflow is supplied to a second area or one or more second rooms of the building.

The HVAC-P system of any preceding clause, wherein the first area or the one or more first rooms of the building includes a different predetermined setpoint temperature than the second area or the one or more second rooms of the building.

The HVAC-P system of any preceding clause, wherein the HVAC-P system includes at least two generators, at least three generators, or even at least four generators.

The HVAC-P system of any preceding clause, wherein the generators are individually operable in each of the heating mode and the cooling mode.

The HVAC-P system of any preceding clause, wherein the battery system is coupled to the generator, the electrical grid, or a combination thereof.

The HVAC-P system of any preceding clause, wherein the battery system includes one or more batteries or battery packs.

The HVAC-P system of any preceding clause, wherein the generator supplies the generated electrical power to the battery system to charge the battery packs.

The HVAC-P system of any preceding clause, wherein the battery packs store electrical power and selectively supply the electrical power to the generator, the building, the electrical grid, or a combination thereof upon demand.

The HVAC-P system of any preceding clause, wherein the battery system selectively supplies the electrical power to the generator to operate the generator in the cooling mode.

The HVAC-P system of any preceding clause, wherein the battery system selectively supplies the electrical power to the building to operate electric or electronic components or systems of the building.

The HVAC-P system of any preceding clause, wherein the battery system selectively supplies the electrical power through one or more electrical outlets in the building and is configured to operate electric or electronic devices or systems connected to the one or more electrical outlets.

The HVAC-P system of any preceding clause, wherein the battery system selectively supplies the electrical power to the electrical grid to support the total electrical power available from the electrical grid.

The HVAC-P system of any preceding clause, wherein the battery system selectively supplies the generated electrical power to the electrical grid upon a demand or request from the electrical grid.

The HVAC-P system of any preceding clause, wherein the battery system includes a battery management controller configured to selectively control an amount of the electrical power supplied from the battery system to the generator, the building, the electrical grid, or a combination thereof upon demand.

The HVAC-P system of any preceding clause, wherein the battery management controller controls the charging of the battery packs by the generator.

The HVAC-P system of any preceding clause, wherein the battery system includes a battery cooling system to regulate a temperature of the one or more batteries or battery packs.

The HVAC-P system of any preceding clause, further comprising: a housing configured for installation in the building and containing the generator, the one or more fuel sources, the battery system, the system controller, or a combination thereof.

The HVAC-P system of any preceding clause, wherein housing includes a cylindrical shape or a rectangular cuboid shape.

The HVAC-P system of any preceding clause, wherein the housing includes a footprint of less than 48×48 inches (about 1220×1220 mm), less than 36×36 inches (about 915×915 mm), or even less than 24×24 inches (about 610×610 mm).

The HVAC-P system of any preceding clause, wherein the housing includes a maximum dimension of a height or length of less than 72 inches (about 1830 mm), less than 60 inches (about 1524 mm), less than 48 inches (about 1220 mm), or even less than 36 inches (about 915 mm).

The HVAC-P system of any preceding clause, wherein the housing includes one or more inlets and one or more outlets to allow airflow through the housing.

The HVAC-P system of any preceding clause, wherein the housing includes one or more connections for electrical power outputs, heating outputs, and cooling outputs.

The HVAC-P system of any preceding clause, wherein the housing includes one or more connections for the one or more fuel sources, the electrical grid, or a combination thereof.

The HVAC-P system of any preceding clause, wherein the system controller executes instructions to control operation of the HVAC-P system.

The HVAC-P system of any preceding clause, wherein the system controller executes instructions to selectively control delivery of the heated airflow and the cooled airflow to the building.

The HVAC-P system of any preceding clause, wherein the system controller executes instructions to selectively control delivery of the generated electrical power from the generator to the battery system, the building, the electrical grid, or a combination thereof.

The HVAC-P system of any preceding clause, wherein the system controller executes instructions to selectively control delivery of the electrical power from the battery system to the to the generator, the building, the electrical grid, or a combination thereof.

The HVAC-P system of any preceding clause, wherein the system controller executes instructions to selectively control which of the one or more fuels are burned by the generator.

The HVAC-P system of any preceding clause, wherein the system controller is communicatively coupled to one or more user interfaces.

The HVAC-P system of any preceding clause, wherein the user interface is integrated with the system controller.

The HVAC-P system of any preceding clause, wherein the user interface is remotely located from the system controller.

The HVAC-P system of any preceding clause, wherein the system controller is responsive to inputs made via the user interface.

The HVAC-P system of any preceding clause, wherein the system controller selectively operates the HVAC-P system in each of the heating mode and the cooling mode in response to a demand for heating or cooling, respectively, received through the user interface, in response to an ambient air temperature in the building exceeding a predetermined setpoint temperature stored in the user interface, or a combination thereof.

The HVAC-P system of any preceding clause, wherein the system controller selectively operates the HVAC-P system in response to a demand for electrical power received through the user interface, from the building, from the electrical grid, or a combination thereof.

The HVAC-P system of any preceding clause, wherein the system controller operates the HVAC-P system to maintain a minimum state-of-charge of the battery system.

A method of operating a heating, ventilation, and/air conditioning (HVAC-P) system for a building, comprising: providing an HVAC-P system comprising a generator configured to selectively operate in each of a heating mode and a cooling mode, and a system controller that executes instructions to selectively control operation of the HVAC-P system in each of the heating mode and cooling mode; and operating the HVAC-P system in: the heating mode, wherein in the heating mode, the generator burns one or more fuels to generate and supply a heated airflow to the building and electrical power to a battery system, the building, the electrical grid, or a combination thereof; or the cooling mode, wherein in the cooling mode, the generator operates on electrical power provided by the battery system, the electrical grid, or a combination thereof to generate and supply a cooled airflow to the building.

The method of any preceding clause, further comprising: operating the HVAC-P system in the heating mode and switching from operating the HVAC-P system in the heating mode to operating the HVAC-P system in the cooling mode.

The method of any preceding clause, further comprising: operating the HVAC-P system in the cooling mode and switching from operating the HVAC-P system in the cooling mode to operating the HVAC-P system in the heating mode.

The method of any preceding clause, wherein the HVAC-P system is operated in the heating mode by the system controller in response to a demand for heating and/or electrical power received through a user interface communicatively coupled to the system controller, in response to an ambient air temperature in the building exceeding a predetermined setpoint temperature stored in the user interface, or a combination thereof.

The method of any preceding clause, wherein the HVAC-P system is operated in the cooling mode by the system controller in response to a demand for cooling received through the user interface communicatively coupled to the system controller, in response to an ambient air temperature in the building exceeding a predetermined setpoint temperature stored in the user interface, or a combination thereof.

A method of operating a heating, ventilation, and/air conditioning (HVAC-P) system for a building, comprising: providing an HVAC-P system comprising a plurality of generators configured to independently operate in each of a heating mode and a cooling mode, and a system controller that executes instructions to selectively control operation of the HVAC-P system in each of the heating mode and cooling mode; operating at least one of the plurality of generators in the heating mode, wherein in the heating mode, the generator burns one or more fuels to generate and supply a heated airflow to the building and electrical power to a battery system, the building, the electrical grid, or a combination thereof; and simultaneously operating at least one of the plurality of generators in the cooling mode, wherein in the cooling mode, the generator operates on electrical power provided by the battery system, the electrical grid, or a combination thereof to generate and supply a cooled airflow to the building.

The method of any preceding clause, further comprising: switching from operating at least one of the plurality of generators in the heating mode to operating the at least one generator in the cooling mode.

The method of any preceding clause, further comprising: switching from operating at least one of the plurality of generators in the cooling mode to operating the at least one generator in the heating mode.

The method of any preceding clause, further comprising: operating each of the plurality of generators in the heating mode.

The method of any preceding clause, further comprising: operating each of the plurality of generators in the cooling mode.

The method of any preceding clause, wherein at least one of the plurality of generators is operated in the heating mode by the system controller in response to a demand for heating and/or electrical power received through a user interface communicatively coupled to the system controller, in response to an ambient air temperature in the building exceeding a predetermined setpoint temperature stored in the user interface, or a combination thereof.

The method of any preceding clause, wherein at least one of the plurality of generators is operated in the cooling mode by the system controller in response to a demand for cooling received through the user interface communicatively coupled to the system controller, in response to an ambient air temperature in the building exceeding a predetermined setpoint temperature stored in the user interface, or a combination thereof.

Note that not all of the activities or features described above in the detailed description or in the examples are required, that a portion of a specific activity or feature may not be required, and that one or more further activities or features may be performed in addition to those described. Still further, the order in which activities are listed is not necessarily the order in which they are performed.

In the foregoing specification, the concepts have been described with reference to specific embodiments. However, those of ordinary skill in the art appreciate that various modifications and changes can be made without departing from the scope of the invention as set forth in the claims below. Accordingly, the specification and figures are to be regarded in an illustrative rather than in a restrictive sense, and all such modifications are intended to be included within the scope of the invention.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present), and B is true (or present), and both A and B are true (or present).

Also, the use of “a” or “an” is employed to describe elements and components described herein. This is done merely for convenience and to give a general sense of the scope of the invention. This description should be read to include one or at least one, and the singular also includes the plural unless it is obvious that it is meant otherwise.

Benefits, other advantages, and solutions to problems have been described above with respect to one or more specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, those of ordinary skill in the art will appreciate that certain features that are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A heating, ventilation, air conditioning, and electrical power generation (HVAC-P) system for a structure, comprising:
a fuel agnostic generator configured to selectively operate in each of a heating mode and a cooling mode,
wherein, in the heating mode, the fuel agnostic generator burns one or more fuels to generate and supply a heated airflow to the structure and electrical power to at least one of a battery system, the structure, or an electrical grid, and
wherein, in the cooling mode, the fuel agnostic generator operates on electrical power provided by at least one of the battery system or the electrical grid to generate and supply a cooled airflow to the structure; and
a system controller that executes instructions to selectively control operation of the HVAC-P system in each of the heating mode and cooling mode.

2. The HVAC-P system of claim 1, wherein the fuel agnostic generator is configured to burn compressed natural gas, liquified natural gas, diesel, hydrogen, liquified petroleum gas, propane, kerosene, dimethyl ether (DME), or any combination thereof to generate electrical power to charge the battery system, and wherein emissions from the fuel agnostic generator comprise only carbon dioxide, nitrogen, water, or a combination thereof.

3. The HVAC-P system of claim 1, wherein the heated airflow comprises a higher temperature than an ambient air temperature in the structure, and wherein the heated airflow increases the ambient air temperature in the structure.

4. The HVAC-P system of claim 1, wherein the cooled airflow comprises a lower temperature than an ambient air temperature in the structure, and wherein the cooled airflow decreases the ambient air temperature in the structure.

5. The HVAC-P system of claim 1, wherein, in the cooling mode, the fuel agnostic generator is powered by electrical power from the battery system, the electrical grid, or a combination thereof without burning the one or more fuels.

6. The HVAC-P system of claim 1, further comprising: a cooling system coupled to the fuel agnostic generator and configured to regulate an operating temperature of the fuel agnostic generator.

7. The HVAC-P system of claim 1, wherein the fuel agnostic generator is coupled to one or more fuel sources that supply the one or more fuels to the fuel agnostic generator, and wherein the one or more fuel sources comprises an internal fuel source having a fuel tank that stores fuel and supplies the fuel upon demand to the fuel agnostic generator.

8. The HVAC-P system of claim 1, wherein the HVAC-P system comprises a plurality of generators.

9. The HVAC-P system of claim 8, wherein the HVAC-P system is configured to selectively supply the heated airflow and/or electrical power simultaneously with the cooled airflow.

10. The HVAC-P system of claim 9, wherein the plurality of generators comprises, at least, a first generator or a first set of generators that operate in the heating mode and burns one or more fuels to generate and supply the heated airflow and/or electrical power and a second generator or second set of generators that operate in the cooling mode to generate and supply the cooled airflow without burning the one or more fuels.

11. The HVAC-P system of claim 10, wherein the heated airflow is provided to a first area or one or more first rooms of the structure, and wherein the cooled airflow is supplied to a second area or one or more second rooms of the structure.

12. The HVAC-P system of claim 8, wherein the plurality of generators are individually operable in each of the heating mode and the cooling mode.

13. The HVAC-P system of claim 1, wherein the battery system comprises one or more batteries or battery packs, and wherein the fuel agnostic generator supplies the generated electrical power to the battery system to charge the battery packs, and wherein the battery packs store electrical power and selectively supply the electrical power to the fuel agnostic generator, the structure, the electrical grid, or a combination thereof upon demand.

14. The HVAC-P system of claim 1, wherein the battery system comprises a battery management controller configured to selectively control an amount of the electrical power supplied from the battery system to the fuel agnostic generator, the structure, the electrical grid, or a combination thereof upon demand.

15. The HVAC-P system of claim 14, wherein the battery management controller controls the charging of the battery packs by the generator.

16. The HVAC-P system of claim 13, wherein the battery system comprises a battery cooling system to regulate a temperature of the one or more batteries or battery packs.

17. The HVAC-P system of claim 7, further comprising: a housing configured for installation in the structure and containing the fuel agnostic generator, the one or more fuel sources, the battery system, the system controller, or a combination thereof.

18. A method of operating a heating, ventilation, and/air conditioning (HVAC-P) system for a structure, the method comprising:
providing an HVAC-P system having a fuel agnostic generator configured to selectively operate in each of a heating mode and a cooling mode, and a system controller that executes instructions to selectively control operation of the HVAC-P system in each of the heating mode and the cooling mode; and
operating the HVAC-P system in: the heating mode, wherein in the heating mode, the fuel-agnostic generator burns one or more fuels to generate and supply a heated airflow to the structure and electrical power to a battery system, the structure, an electrical grid, or a combination thereof; or the cooling mode, wherein in the cooling mode, the fuel-agnostic generator operates on electrical power provided by the battery system, the electrical grid, or a combination thereof to generate and supply a cooled airflow to the structure.

19. The method of any claim 18, further comprising:
operating the HVAC-P system in the heating mode by the system controller in response to a demand for heating and/or electrical power received through a user interface communicatively coupled to the system controller, in response to an ambient air temperature in the structure exceeding a predetermined setpoint temperature stored in the user interface, or a combination thereof; and
operating the HVAC-P system in the cooling mode by the system controller in response to a demand for cooling received through the user interface communicatively coupled to the system controller, in response to an ambient air temperature in the structure exceeding a predetermined setpoint temperature stored in the user interface, or a combination thereof.

20. The method of claim 18, wherein the fuel agnostic generator is one of a plurality of generators, the method further comprising: simultaneously operating at least one of the plurality of generators in the cooling mode, wherein in the cooling mode, the fuel agnostic generator operates on electrical power provided by the battery system, the electrical grid, or a combination thereof to generate and supply a cooled airflow to the structure.
